(19) United States
(12) Patent Application Publication
(10) Pub. No.: US 2025/0068481 A1
(43) Pub. Date: Feb. 27, 2025

(54) SYSTEMS AND METHODS FOR RECOMMENDING LOAD REBALANCING BASED ON LEARNED PATTERNS OF RECURRENCE

(71) Applicant: Capital One Services, LLC, McLean, VA (US)

(72) Inventors: Samuel RAPOWITZ, Roswell, GA (US); Julian DUQUE, Arlington, VA (US); Nathan WOLFE, Silver Spring, MD (US); Jina ZHOU, Sugar Land, TX (US); Helen TEMESGHEN-BLOUNT, Washington, DC (US); Dennis LIU, Richmond, VA (US)

(73) Assignee: Capital One Services, LLC, McLean, VA (US)

(21) Appl. No.: 18/454,434

(22) Filed: Aug. 23, 2023

(51) Int. Cl. G06F 9/50

(52) U.S. Cl. CPC G06F 9/505

(57) ABSTRACT

Methods and systems are disclosed herein to recommend load rebalancing based on learned patterns of recurrence. In some aspects, the method receives a requested load usage from a user system and a load usage dataset. Each entry in the load usage dataset corresponds to an instance of load use. The method determines similar instances based on a respective amount and respective category of each entry. The method then clusters the similar instances into a first cluster and a second cluster based on frequencies of the similar instances. The method combines load uses corresponding to the first cluster into a first recurring load use and load uses corresponding to the second cluster into a second recurring load use. The method compares the requested load usage to the second recurring load use to generate a recommendation to the user system for rebalancing load usage.

### BACKGROUND

A current approach to identifying load usages that are discretionary as opposed to required is to look at a log of the user system's load usage history. In the log, any descriptions or labels that load usages are tagged with may be used for natural language processing to group load usages into necessary and discretionary usages. However, grouping this data is difficult as there is not enough data available to determine based on comparing the records what is discretionary and what is required load usage using current natural language processing techniques of the load usage descriptions.

### SUMMARY

Methods and systems are described herein for improvements to providing recommendations for rebalancing load usage. For example, existing systems for recommending load rebalancing often do not differentiate between necessary and discretionary load usage. Their failure to make this distinction results in inaccurate recommendations poorly tailored to the specific circumstances of the system's load usage. Existing systems do not differentiate between necessary and discretionary load usage because there is no known method to ascertain from load usage logs alone the necessity of instances of load usage. To complicate matters further, instances of load usage identical in amount, target, and other respects may still differ in degrees of necessity.

To overcome this technical deficiency, methods and systems disclosed herein provide a novel method for recommending load rebalancing based on distinguishing discretionary load usages from necessary load usages via clustering using frequencies at which the load usages occur. In particular, methods and systems disclosed herein determine similar instances of load usage and additionally cluster the similar instances based on frequencies of the similar instances.

For example, methods and systems disclosed herein select a subset of features describing instances of load usage, use the subset of features to represent load uses in a real-valued embedding space, calculate a distance matrix weighted using frequency, and use the distance matrix to identify similar instances of load usages. In another example, methods and systems disclosed herein use a machine learning model to select similar instances of load usages. The machine learning model takes as input the set of features describing load usages in addition to frequencies of the load usages. By utilizing the frequencies of occurrence of load usages, methods and systems disclosed herein can accurately categorize load usages into discretionary and necessary and thereby provide pertinent and actionable recommendations for load rebalancing.

In some aspects, a method is herein disclosed for recommending load rebalancing based on learned patterns of recurrence, the method comprising: receiving a request from a user system to rebalance load usage, wherein the request comprises a requested load usage; receiving a load usage dataset over a first period of time, wherein each entry in the load usage dataset corresponds to an instance of load use and specifies an amount and a category of the instance of load use; determining similar instances based on a respective amount and respective category of each entry; clustering the similar instances into a first cluster and a second cluster based on frequencies of the similar instances, wherein the first cluster corresponds to high-frequency similar instances, and wherein the second cluster corresponds to low-frequency similar instances; combining one or more load uses corresponding to the first cluster into a first recurring load use in the load usage dataset; combining one or more load uses corresponding to the second cluster into a second recurring load use in the load usage dataset; comparing a requested load usage to the second recurring load use; and generating a recommendation to the user system for rebalancing load usage for a second period of time based on comparing the requested load usage to the second recurring load use.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system used for generating recommendations for rebalancing load usage, in accordance with one or more embodiments.

FIG. 2 shows an illustrative diagram for generating recommendations for rebalancing load usage, in accordance with one or more embodiments.

FIG. 3 shows illustrative components for a system used in generating recommendations for rebalancing load usage, in accordance with one or more embodiments.

FIG. 4 shows a flowchart of the steps involved in generating recommendations for rebalancing load usage, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

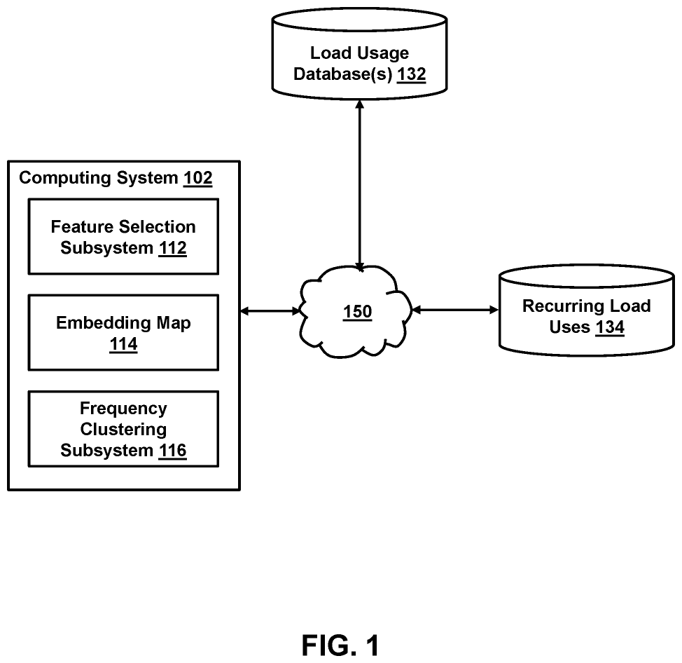

FIG. 1 shows an illustrative diagram for system 150, a computer system for detecting, assessing, and responding to access to sensitive information, in accordance with one or more embodiments. For example, system 150 (the “system”) includes Computing System 102, Load Usage Database(s) 132, and Recurring Load Uses 134.

The system may receive, access, and/or modify Load Usage Database(s) 132. Load Usage Database(s) 132 contains a plurality of load usages over a first period of time. Load Usage Database(s) 132 may, for example, be a relational database, containing a set of entries for the relational database (also referred to as “data points”). Each entry in Load Usage Database(s) 132 corresponds to an instance of load usage and contains information described by a set of features. In some embodiments, the set of features may be referred to as a set of parameters. Each parameter may describe one aspect of an instance of load usage, and hence a subset of parameters may depict partial information about the instance of load usage.

An instance of load usage is an event where a user system consumes a resource, for example, computational bandwidth on a computer network or electricity wattage on an electric grid. Each instance of load usage (or “load usage” for short) corresponds to a moment in time. For example, an entry in Load Usage Database(s) 132 may symbolize an instance of usage where 37 kilowatts of electricity were used by a device in a three-hour period of time. An instance of load usage may be defined by a start time and an end time, where the resource is consumed between the start time and the end time. Some load usages may recur, for example, a computer may use 200 megabits of bandwidth every Monday at 8:00 a.m. Load Usage Database(s) 132 may store recurring load usages as separate instances. The set of features (or parameters) in Load Usage Database(s) 132 may contain categorical or quantitative variables, and values for such features may describe, for example, an extent and frequency of the load usage, the purpose or destination of the load usage, a time period or timestamp associated with the load usage, and the method in which network resources were used in the load usage, among others. The system may retrieve a plurality of load usage instances as a matrix including vectors of feature values for the set of features. In some embodiments, the set of features may not include frequency and the system consequently may infer frequencies of load usages from the log of load usages. For example, two entries with identical values in all features except timestamp may be considered two occurrences of the same load usage. If such entries occur once every 30 days, the system may consider the load usage to have a frequency of once every month.

In some embodiments, the system may process Load Usage Database(s) 132 using a data cleansing process to generate a processed dataset. The data cleansing process may include removing outliers, standardizing data types, formatting units of measurement, and removing duplicate data. The system may then retrieve vectors corresponding to load usage instances from the processed dataset.

Computer System 102 includes Feature Selection Subsystem 112, Embedding Map 114, and Frequency Clustering Subsystem 116.

Feature Selection Subsystem 112 may select a subset of features from the set of features in Load Usage Database(s) 132. Using the subset of features, the system may project entries in Load Usage Database(s) 132 into a real-valued space. Feature Selection Subsystem 112 may use metrics that assess the importance of features in Load Usage Database(s) 132. For example, Feature Selection Subsystem 112 may generate a covariance matrix using the full set of features of the load usage dataset. In some embodiments, the covariance matrix may be referred to as a correlation matrix. The covariance matrix may capture correlations between a feature in the set of features and other features of the set. For example, the covariance matrix may capture the statistical joint variability between each pair of features in the set of features, which may be calculated by the expectation of the product of the two features minus the product of the expectation of one feature multiplied by the expectation of the other feature. Feature Selection Subsystem 112 may determine a set of eigenvectors and eigenvalues for the covariance matrix (e.g., through the singular value decomposition method). Each eigenvector corresponds to an eigenvalue and represents a feature in Load Usage Database(s) 132. By normalizing the eigenvalues of all features in the set of features, the system may determine what percentage of the variability and explanative power of Load Usage Database(s) 132 may be captured by each feature. Feature Selection Subsystem 112 may then select a measure of coverage and select a subset of eigenvectors from the set of eigenvectors based on the measure of coverage. For example, if the measure of coverage is 55%, and three eigenvectors' eigenvalues add up to 56% when normalized, Feature Selection Subsystem 112 may select the three eigenvectors. Feature Selection Subsystem 112 may then determine a subset of parameters corresponding to the subset of eigenvectors. In the above example, the three features corresponding to the three selected eigenvectors may be selected to constitute the subset of features.

In some embodiments, after Feature Selection Subsystem 112 has processed the covariance matrix (also referred to herein as a “correlation matrix”) to generate a set of eigenvectors, Feature Selection Subsystem 112 may compute a distribution of eigenvalues corresponding to the set of eigenvectors. Using the distribution of eigenvalues, the system may set a threshold and use a maximum-likelihood estimator model to extract the second set of features. For example, the maximum-likelihood estimator model may output a feature that is most correlated with the load usage amount in Load Usage Database(s) 132. The process can be repeated to rank the features by correlation with load usage amount. Feature Selection Subsystem 112 may then select a set number of features most highly correlated with the load usage amount to be the subset of features. In some embodiments, the subset of features may be a transformation or recombination of the full set of features in Load Usage Database(s) 132.

Having selected a second set of features, the system may generate an embedding map (e.g., Embedding Map 114) to translate entries in Load Usage Database(s) 132 into a real-valued embedding space. Embedding Map 114 may be a series of rules and transformations that take a vector of input data (e.g., values for features in the full set of features), apply mathematical transformations like weight multiplications and Boolean combinations to the vector of input data, and produce an output vector that may represent feature values for the subset of features. For example, an input vector of the values [23, 0.7, 100, 66, 80.4] may be taken into Embedding Map 114. Embedding Map 114 may multiply the first feature by 1.774 to obtain the first output value. Embedding Map 114 may determine whether the second feature is greater than 0.5: if it is, the second output value is set to 1, and if not, it is set to 0. Embedding Map 114 may calculate a difference between the third and fourth features (e.g., 34) to be the third output value. Embedding Map 114 may ignore the fifth feature. Embedding Map 114, in this example, has taken an input vector of [23, 0.7, 100, 66, 80.4] and output a vector of values [40.802, 1, 34]. In another example, Embedding Map 114 may translate categorical variables. For example, the feature of “industry group” with the value of “real estate” may be represented as 503 in the output. Embedding Map 114 may store weights, rules, and other information in hardware and/or software.

In some embodiments, the system may exclude some features from consideration. For example, the system may receive a user request specifying that certain parameters be removed from consideration or that the impact of some parameters be reduced. In one example embodiment, the system may receive user profiles representing applicants for credit cards. A feature in the set of features may be the race or ethnicity of the applicant. The user may wish to exclude such features from consideration. Therefore, the features to be removed may include, e.g., race and gender. Feature Selection Subsystem 112 may avoid those features in the subset of features it selects to project entries in Load Usage Database(s) 132 onto. Alternatively or additionally, Embedding Map 114 may apply a mathematical transformation such that values corresponding to the subset of features are adjusted. For example, the weights used to multiply the subset of features may be set to zero or the values may be halved.

After Embedding Map 114 translates entries in Load Usage Database(s) 132 into the embedding space, Frequency Clustering Subsystem 116 may calculate a distance matrix including distances between one or more entries. For example, Frequency Clustering Subsystem 116 may select a distance formula, such as Euclidean distance, Cosine similarity, Jaccard Index, or Hamming distance. Using the selected distance formula, Frequency Clustering Subsystem 116 may calculate a distance for each pair of entries in the load usage dataset in the real-valued embedding space for storage in the distance matrix. Each entry in Load Usage Database(s) 132 may be represented as a real-valued vector using Embedding Map 114. The distance may be mathematically determined between two real-valued vectors using one of the above distance formulae. A greater distance between two real vectors representing two load usages is indicative of less similarity between the two load usages, and vice versa. In some embodiments, Frequency Clustering Subsystem 116 may calculate a frequency similarity score for each pair of entries in the load usage dataset. The frequency similarity score represents the similarity between two entries in terms of frequency of occurrence. For example, if two entries both recur once every month, their similarity score may be 1. The system may then divide the distance for each pair of entries in the load usage dataset by the corresponding frequency similarity score. By doing so, similarity in frequency is also accounted for when considering load usage instances for combination into recurring load uses.

After calculating the distance matrix, the system may use the distance matrix to identify groups of load usage instances to combine into recurring load uses. The system may select a distance threshold. In some embodiments, the distance threshold may be the smaller one of a preset maximum threshold and a distance at a particular percentile rank of distances in the distance matrix (the flexible distance threshold). For example, if the preset maximum threshold is 12, and the flexible distance threshold is determined to be 15, the distance threshold may be selected to be 12. The system may then compare each distance in the distance matrix against the distance threshold. The system may detect a group of instances where for each pair of instances within the group of instances the distance for the pair is shorter than the distance threshold. The system may deem this group sufficiently similar for combination into clusters.

In some embodiments, the system may use a machine learning model to determine similar instances of load usage. For example, frequency may be added as a feature in the set of features describing load usage instances in Load Usage Database(s) 132. The plurality of entries in the load usage dataset may then be input as feature values into the machine learning model. The machine learning model may use an algorithm such as K-means, hierarchical clustering, or DBSCAN. The machine learning model may output one or more groups of similar load use instances.

For example, the system may retrieve a first set of frequency data for each instance in the group of instances. The system may then select a threshold frequency based on the first set of frequency data and the distance matrix. For example, the system may select the median frequency in the distance matrix to be the threshold frequency. The system may combine into the first cluster all instances in the group of instances that exceed the threshold frequency and combine into the second cluster all instances in the group of instances that do not exceed the threshold frequency. The first cluster, corresponding to necessary and inelastic spending, may be combined into the first recurring load use. The second cluster, corresponding to discretionary and elastic spending, may be combined into the second recurring load use. The first and second recurring load uses may be stored as Recurring Load Uses 134. A recurring load use may be a data structure corresponding to a recurring load usage, where instances of load usage by a user system occur regularly. A recurring load use may, for example, be defined by an extent of load usage and a frequency of occurrence.

For each group in all groups of similar instances, the instances exceeding the frequency threshold may be combined into a first recurring load use, and all other instances may be combined into a second recurring load use. The plurality of second recurring load uses in Recurring Load Uses 134 represent discretionary expenditures or load uses and constitute the maximal extent to which a new expenditure can be made. For example, the system may determine that a user with a monthly budget of 5,000 has first recurring load uses totaling 3,500 and second load uses totaling 1,500. That is, the user has a disposable limit of 1,500. A purchase of 1,800 therefore cannot be made by this user using discretionary funds at their disposal. In such situations, the system may generate a notification to the user that the requested expenditure cannot be achieved. Similarly, for a computer network using network resources that the system determines to have first recurring load uses totaling 6,400 and second recurring load uses of 400, a task that requires 600 units of network resources cannot be completed. The system may thus generate a notification to the user system that the requested load usage cannot be achieved.

In some embodiments, the requested load usage may indicate a total extent of load usage that the user would like to achieve. For example, the current expenditure of the user may be 3,200 per month, but the user would like to reduce their expenditure to 2,600 per month. The system may thus determine a measure of discrepancy, which indicates a difference between the current expenditure and the requested load usage and the current load usages as may be found in Load Usage Database(s) 132. In the above example, the measure of discrepancy would be 600 per month. The system may compare the measure of discrepancy against the second recurring load use. If the second recurring load use is less than the measure of discrepancy, the system may generate a notification to the user system that the requested load usage cannot be achieved.

In some embodiments, the system may determine elasticity scores for one or more load usage instances and/or recurring load uses in Load Usage Database(s) 132 and/or Recurring Load Uses 134. A higher elasticity score indicates a higher feasibility of reducing an extent of a load use. The system may use an elasticity machine learning model to determine elasticity scores for load usage instances and/or recurring load uses. The elasticity machine learning model may take as input the set of features in Load Usage Database(s) 132 and frequency data corresponding to load usage instances and/or recurring load uses. The elasticity machine learning model may use an algorithm such as linear regression, neural networks, naïve bayes, and random forests. The elasticity machine learning model may be trained on labeled data including past load usage instances and/or recurring load uses and recommended adjustments to load usage.

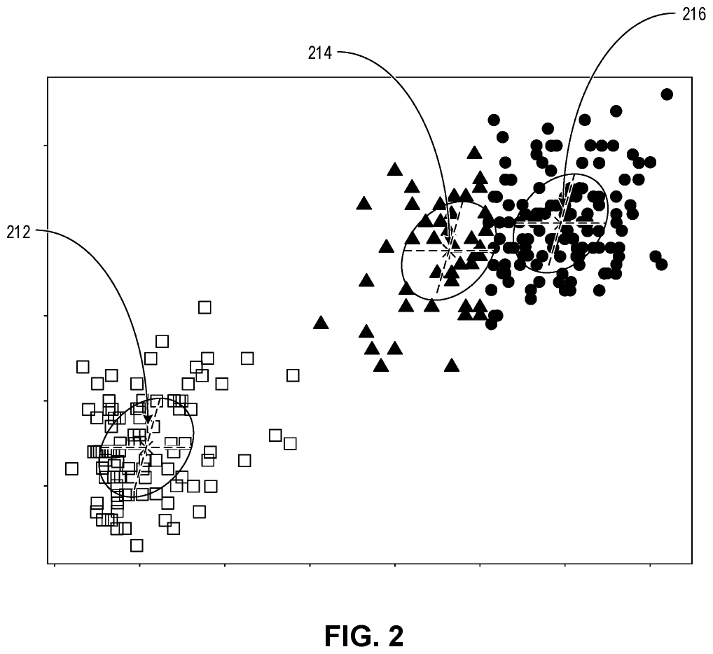

FIG. 2 shows an illustrative diagram for clusters formed from similar instances of load usage. FIG. 2 contains cluster 212, cluster 214, and cluster 216 shown in a real-valued embedding space. Data points represented in FIG. 2 correspond to instances of load usage and are shown as two-dimensional points. The shapes of each data point correspond to the cluster that the data point was assigned to.

The system may assign data points to clusters by computing distances between data points, which are real-valued representations of instances of load usage. For example, Embedding Map 114 may translate one or more vectors in Load Usage Database(s) 132 into points represented in the space shown in FIG. 2. The system may select a distance formula, e.g., Euclidean distance. For each data point, the system may calculate a distance from the data point to each other data point and thus determine a set of raw computed distances. The raw computed distances may be processed using frequency similarity scores between each pair of data points to determine the distance matrix.

The system may use the distance matrix to select a distance threshold. For example, the distribution of distances in the distance matrix may be right-skewed with half of all the distances falling below a threshold (e.g., 0.8). The system may thus select the distance threshold to be 0.8. The resulting clusters, as shown by FIG. 2, are such that each data point in cluster 212 has a distance of no more than 0.8 from at least one other data point in cluster 212. The same relationship applies within data points of cluster 214 and within data points of cluster 216.

Each of the clusters 212, 214, and 216 may have a central zone of concentration. This zone of concentration may correspond to an archetype for a load usage. In some embodiments, data points within a certain distance of the archetype for the load usage may be combined into a recurring load use within Recurring Load Uses 134. The distance may be dynamically determined or preset.

Within each of the clusters 212, 214, and 216, instances of load usage with high frequency may be separated from instances with low frequency using a frequency threshold. For example, the frequency threshold may be a percentile of the frequencies of the distance matrix (i.e., of all instances of load usage) or a percentile of only the cluster of instances of load usage. Alternatively, the frequency threshold may be a fixed value. The system may, using the frequency threshold, combine certain data within cluster 212 into a first recurring load use and other data within cluster 212 into a second recurring load use. The same may be performed on cluster 214 and cluster 216. Thus, three high-frequency recurring load uses and three low-frequency recurring load uses may be generated for Recurring Load Uses 134. The total amount of the three low-frequency recurring load uses add up to an amount representing the discretionary load usages of the user system.

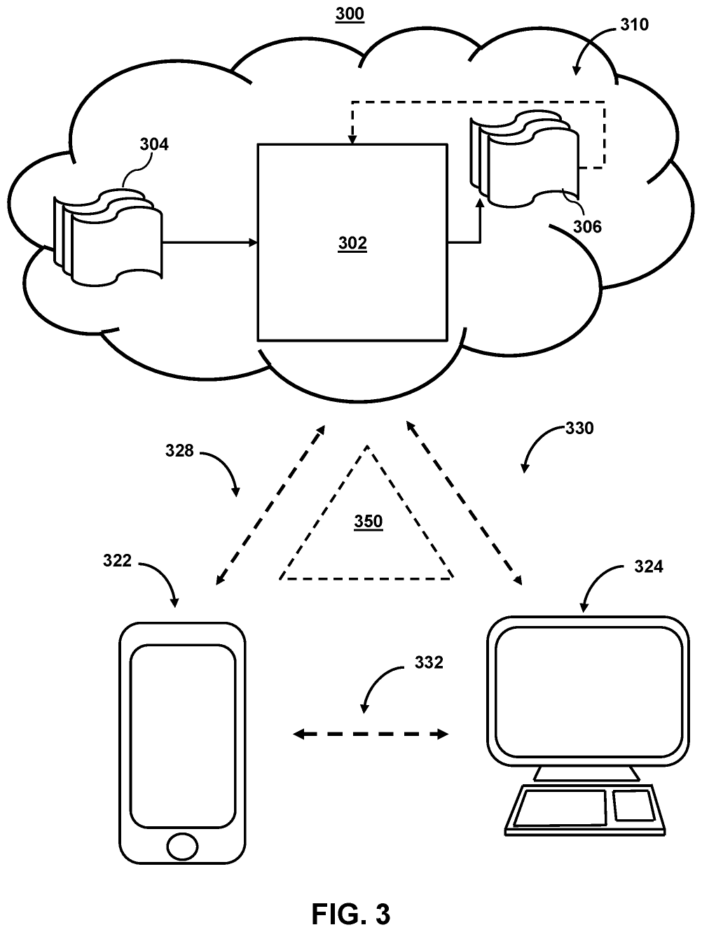

FIG. 3 shows illustrative components for a system used to detect, assess, and respond to access to sensitive information, in accordance with one or more embodiments. For example, FIG. 3 may show illustrative components that may retrieve exposure vectors, train models, and invalidate security credentials. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, virtual private networks, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include Computer System 102 in FIG. 1.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., using the elasticity machine learning model to assign elasticity scores to instances of load usage).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem-solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., K-nearest neighbors clustering to identify triggering events similar to a particular triggering event).

In some embodiments, the model (e.g., model 302) may automatically perform actions based on outputs 306. In some embodiments, the model (e.g., model 302) may not perform any actions. The output of the model (e.g., model 302) may be used to determine a probability that the sensitive information has been accessed.

System 300 also includes API layer 350. API layer 350 may allow the system to generate summaries across different devices. In some embodiments, API layer 350 may be implemented on user device 322 or user terminal 324. Alternatively or additionally, API layer 350 may reside on one or more of cloud components 310. API layer 350 (which may be A REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front end and back end. In such cases, API layer 350 may use RESTful APIs (exposition to front end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API platforms and their modules. API layer 350 may use a developer portal. API layer 350 may use strong security constraints applying WAF and DDOS protection, and API layer 350 may use RESTful APIs as standard for external integration.

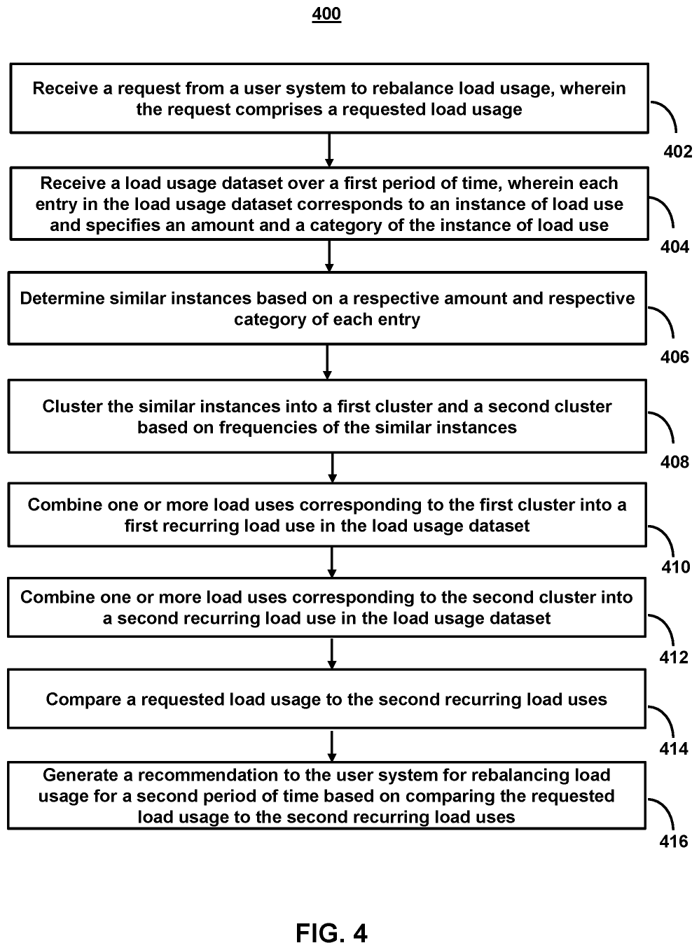

FIG. 4 shows a flowchart of the steps involved in generating recommendations for rebalancing load usage, in accordance with one or more embodiments. For example, the system may use process 400 (e.g., as implemented on one or more system components described above) to generate recommendations for rebalancing load usage by separating discretionary load usages from required load usages with frequency-based clustering.

At step 402, process 400 (e.g., using one or more components described above) receives a request from a user system to rebalance load usage, wherein the request comprises a requested load usage. The user system may be associated with Load Usage Database(s) 132, which details expenditures or load usages across a first period of time. The user may rebalance load usage to accommodate for a new expenditure or to reduce discretionary expenditures. The requested load usage may be described by a numerical amount. The amount may correspond to the extent of the new expenditure or a limit on discretionary expenditures.

At step 404, process 400 (e.g., using one or more components described above) receives a load usage dataset over a first period of time, wherein each entry in the load usage dataset corresponds to an instance of load use and specifies an amount and a category of the instance of load use. The system may receive Load Usage Database(s) 132. Load Usage Database(s) 132 contains a plurality of load usages over a first period of time. Each entry in Load Usage Database(s) 132 corresponds to an instance of load usage and contains information described by a set of features. In some embodiments, instances of load usage may correspond to a consumer's spending from a bank account or drawing from a line of credit, or other financial transactions. The set of features may contain categorical or quantitative variables, and values for such features may describe, for example, an extent and frequency of the load usage, the purpose or destination of the load usage, a time period or timestamp associated with the load usage, and the method in which network resources were used in the load usage, among others. The system may retrieve a plurality of load usage instances as a matrix including vectors of feature values for the set of features. In some embodiments, the system may process Load Usage Database(s) 132 using a data cleansing process to generate a processed dataset. The data cleansing process may include removing outliers, standardizing data types, formatting units of measurement, and removing duplicate data. The system may then retrieve vectors corresponding to load usage instances from the processed dataset.

At step 406, process 400 (e.g., using one or more components described above) determines similar instances based on a respective amount and respective category of each entry. For example, the system may use Feature Selection Subsystem 112 to select a subset of features from the set of features in Load Usage Database(s) 132, use the subset of features to represent load uses in a real-valued embedding space, calculate a distance matrix for load usages, and use the distance matrix to identify similar instances of load usages. For example, Feature Selection Subsystem 112 may generate a covariance matrix using the full set of features of the load usage dataset. The covariance matrix may capture correlations between a feature in the set of features and other features of the set. Feature Selection Subsystem 112 may determine a set of eigenvectors and eigenvalues for the covariance matrix (e.g., through the singular value decomposition method). Each eigenvector corresponds to an eigenvalue and represents a feature in Load Usage Database(s) 132. By normalizing the eigenvalues of all features in the set of features, the system may determine what percentage of the variability and explanative power of Load Usage Database(s) 132 may be captured by each feature. Feature Selection Subsystem 112 may then select a measure of coverage and select a subset of eigenvectors from the set of eigenvectors based on the measure of coverage. For example, if the measure of coverage is 55%, and three eigenvectors' eigenvalues add up to 56% when normalized, Feature Selection Subsystem 112 may select the three eigenvectors. Feature Selection Subsystem 112 may then determine a subset of parameters corresponding to the subset of eigenvectors. In the above example, the three features corresponding to the three selected eigenvectors may be selected to constitute the subset of features.

Having selected a second set of features, the system may generate an embedding map (e.g., Embedding Map 114) to translate entries in Load Usage Database(s) 132 into a real-valued embedding space. Embedding Map 114 may be a series of rules and transformations that take a vector of input data (e.g., values for features in the full set of features), apply mathematical transformations like weight multiplications and Boolean combinations to the vector of input data, and produce an output vector that may represent feature values for the subset of features.

Frequency Clustering Subsystem 116 may calculate a distance matrix including distances between one or more entries. For example, Frequency Clustering Subsystem 116 may select a distance formula, such as Euclidean distance, Cosine similarity, Jaccard Index, or Hamming distance. Using the selected distance formula, Frequency Clustering Subsystem 116 may calculate a distance for each pair of entries in the load usage dataset in the real-valued embedding space. Each entry in Load Usage Database(s) 132 may be represented as a real-valued vector using Embedding Map 114. The distance may be mathematically determined between two real-valued vectors using one of the above distance formulae. A greater distance between two real vectors representing two load usages is indicative of less similarity between the two load usages, and vice versa. In some embodiments, Frequency Clustering Subsystem 116 may calculate a frequency similarity score for each pair of entries in the load usage dataset. The frequency similarity score represents the similarity between two entries in terms of frequency of occurrence. For example, if two entries both recur once every month, their similarity score may be 1. The system may then divide the distance for each pair of entries in the load usage dataset by the corresponding frequency similarity score. By doing so, similarity in frequency is also accounted for when considering load usage instances for combination into recurring load uses.

At step 408, process 400 (e.g., using one or more components described above) clusters the similar instances into a first cluster and a second cluster based on frequencies of the similar instances. The system may select a distance threshold. In some embodiments, the distance threshold may be the smaller one of a preset maximum threshold and a distance at a particular percentile rank of distances in the distance matrix (the flexible distance threshold). For example, if the preset maximum threshold is 12, and the flexible distance threshold is determined to be 15, the distance threshold may be selected to be 12. The system may then compare each distance in the distance matrix against the distance threshold. The system may detect a group of instances where for each pair of instances within the group of instances the distance for the pair is shorter than the distance threshold. The system may deem this group sufficiently similar for combination into clusters. In some embodiments, the system may use a machine learning model to cluster the similar instances into a first cluster and a second cluster based on frequencies of the similar instances. For example, frequency may be added as a feature in the set of features describing load usages instances in Load Usage Database(s) 132. The plurality of entries in the load usage dataset may then be input as feature values into the machine learning model. The machine learning model may use an algorithm such as K-means, hierarchical clustering, or DBSCAN. The machine learning model may output one or more groups of similar load use instances.

At step 410, process 400 (e.g., using one or more components described above) combines one or more load uses corresponding to the first cluster into a first recurring load use in the load usage dataset. At step 412, process 400 (e.g., using one or more components described above) combines one or more load uses corresponding to the second cluster into a second recurring load use in the load usage dataset. For example, the system may retrieve a first set of frequency data for each instance in the group of instances. The system may then select a threshold frequency based on the first set of frequency data and the distance matrix. For example, the system may select the median frequency in the distance matrix to be the threshold frequency. The system may combine into the first cluster all instances in the group of instances that exceed the threshold frequency and combine into the second cluster all instances in the group of instances that do not exceed the threshold frequency. The first cluster, corresponding to necessary and inelastic spending, may be combined into the first recurring load use. The second cluster, corresponding to discretionary and elastic spending, may be combined into the second recurring load use. The first and second recurring load uses may be stored as Recurring Load Uses 134. A recurring load use may be stored as a matrix consisting of vectors corresponding to the load usages instances that were combined into the recurring load use. Thus, a recurring load use corresponds to an extent of load usage, which may be the sum of the extents of load usages in each of the load usages instances within the recurring load use. The plurality of second recurring load uses in Recurring Load Uses 134 represent discretionary expenditures or load uses and constitute the maximal extent to which a new expenditure can be made.

At step 414, process 400 (e.g., using one or more components described above) compares the requested load usage to the second recurring load use. For example, the system may determine that a user with a monthly budget of 5,000 has first recurring load uses totaling 3,500 and second load uses totaling 1,500. That is, the user has a disposable limit of 1,500. A purchase of 1,800 therefore cannot be made by this user using discretionary funds at their disposal. Similarly, for a computer network using network resources that the system determines to have first recurring load uses totaling 6,400 and second recurring load uses of 400, a task that requires 600 units of network resources cannot be completed.

In some embodiments, the requested load usage may indicate a total extent of load usage that the user would like to achieve. For example, the current expenditure of the user may be 3,200 per month, but the user would like to reduce their expenditure to 2,600 per month. Therefore, the system divides expenditures of the user into first recurring load uses totaling 1,800 per month and second recurring load uses totaling 1,400 per month. To attain the requested load usage, the system may compare the first and second recurring load uses against the requested load usage to determine whether the new total expenditure amount can be achieved. The system determines that the requested load usage, being 2,600, exceeds the first recurring load use, which totals 1,800 per month. The system then uses the difference between the requested load usage and the first recurring load use, 800 per month, to determine how much the second recurring load use must be reduced by.

At step 416, process 400 (e.g., using one or more components described above) generates a recommendation to the user system for rebalancing load usage for a second period of time based on comparing the requested load usage to the second recurring load uses. In the above example, to achieve the user's requested load usage, the second recurring load uses have to be reduced to 800 per month, which is the difference between the requested load usage and the first recurring load use. In some embodiments, the system may identify particular instances of load usage to recommend that the user eliminate. For example, the system may send the user system a notification detailing the recurring load uses with the highest elasticities, recommending that the user system cut back on one or more of these recurring load uses. If the system determines that the requested load usage is below the first recurring load use, it may determine that the user cannot reduce discretionary expenditures sufficiently to achieve the required load usage. The system may therefore generate a notification to the user indicating the impossibility, including the amounts of the requested load usage and the first recurring load use. The notification may also recommend that the user adjust the amount of requested load usage.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims, which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising: receiving a request from a user system to rebalance load usage, wherein the request comprises a requested load usage; receiving a load usage dataset over a first period of time, wherein each entry in the load usage dataset corresponds to an instance of load use and specifies an amount and a category of the instance of load use; determining similar instances based on a respective amount and respective category of each entry; clustering the similar instances into a first cluster and a second cluster based on frequencies of the similar instances, wherein the first cluster corresponds to high-frequency similar instances, and wherein the second cluster corresponds to low-frequency similar instances; combining one or more load uses corresponding to the first cluster into a first recurring load use in the load usage dataset; combining one or more load uses corresponding to the second cluster into a second recurring load use in the load usage dataset; comparing a requested load usage to the second recurring load use; and generating a recommendation to the user system for rebalancing load usage for a second period of time based on comparing the requested load usage to the second recurring load uses.

2. The method of any one of the preceding embodiments, wherein determining similar instances comprises: selecting a subset of parameters from a full set of parameters of the load usage dataset; generating an embedding map that translates entries in the load usage dataset into a real-valued embedding space; for each entry in the load usage dataset, using the embedding map to translate its values for the subset of parameters into the embedding space; and calculating a distance matrix comprising distances between one or more entries.

3. The method of any one of the preceding embodiments, further comprising: selecting a distance threshold; comparing each distance in the distance matrix against the distance threshold; and detecting a group of instances, wherein for each pair of instances within the group of instances a distance in the distance matrix for the pair is shorter than the distance threshold.

4. The method of any one of the preceding embodiments, wherein clustering the similar instances into the first cluster and the second cluster comprises: retrieving a first set of frequency data for each instance in the group of instances; selecting a threshold frequency based on the first set of frequency data and the distance matrix; combining into the first cluster all instances in the group of instances that exceed the threshold frequency; and combining into the second cluster all instances in the group of instances that do not exceed the threshold frequency.

5. The method of any one of the preceding embodiments, wherein comparing the requested load usage to the second recurring load uses further comprises: determining a measure of discrepancy between the requested load usage and the load usage dataset; determining that the second recurring load use is less than the measure of discrepancy; and generating a recommendation to the user system that the requested load usage cannot be achieved.

6. The method of any one of the preceding embodiments, wherein selecting the subset of parameters comprises: generating a covariance matrix using the full set of parameters of the load usage dataset; determining a set of eigenvectors for the covariance matrix; selecting a measure of coverage; selecting a subset of eigenvectors from the set of eigenvectors based on the measure of coverage; and determining a subset of parameters corresponding to the subset of eigenvectors.

7. The method of any one of the preceding embodiments, wherein selecting the subset of parameters comprises: determining a set of eigenvectors for the covariance matrix; determining a threshold value using a distribution of the set of eigenvectors; and using a maximum-likelihood estimator model to select the subset of parameters from the covariance matrix, wherein the maximum-likelihood estimator model takes the threshold value as an input.

8. The method of any one of the preceding embodiments, wherein using the embedding map to translate values for the subset of parameters into the embedding space comprises: receiving as input a vector of parameter values representing an entry in the load usage dataset, wherein each parameter value corresponds to a parameter in the subset of parameters, and wherein the vector of parameter values comprises quantitative parameter values and categorical parameter values; applying a preset vector of weights to the quantitative parameter values to generate new quantitative values for the quantitative parameter values; using a set of deterministic rules to generate quantitative values for categorical parameter values; and outputting the new quantitative values for the quantitative parameter values and quantitative values for categorical parameter values.

9. The method of any one of the preceding embodiments, further comprising: receiving a user request specifying that a parameter be removed from consideration or that impact of a parameter be reduced; and applying a mathematical transformation to the vector of parameter values such that a parameter value corresponding to the parameter is adjusted.

10. The method of any one of the preceding embodiments, wherein calculating a distance matrix comprises: selecting a distance formula, wherein the distance formula is one of Euclidean distance, Cosine similarity, Jaccard Index, and Hamming distance; using the distance formula, calculating a distance for each pair of entries in the load usage dataset; calculating a frequency similarity score for each pair of entries in the load usage dataset, wherein the frequency similarity score represents the similarity between two entries in terms of frequency of occurrence; and dividing the distance for each pair of entries in the load usage dataset by the corresponding frequency similarity score.

11. The method of any one of the preceding embodiments, wherein selecting a distance threshold comprises: retrieving a preset maximum distance threshold; determining a percentile rank for distances in the distance matrix; determining a flexible distance threshold, wherein the flexible distance threshold is a distance at a particular percentile rank of distances in the distance matrix; and setting the distance threshold to be the smaller of the flexible distance threshold and the preset maximum distance threshold.

What is claimed is:

1. A system for recommending load rebalancing based on learned patterns of recurrence, the system comprising:
receiving a request from a user system to rebalance load usage, wherein the request comprises a requested load usage;
receiving a load usage dataset over a first period of time, wherein each entry in the load usage dataset corresponds to an instance of load use and specifies an amount and a category of the instance of load use;
determining similar instances based on a respective amount and respective category of each entry;
clustering the similar instances into a first cluster and second cluster based on frequencies of the similar instances, wherein the first cluster corresponds to high-frequency similar instances, and wherein the second cluster corresponds to low-frequency similar instances;
combining one or more load uses corresponding to the first cluster into a first recurring load use in the load usage dataset;
combining one or more load uses corresponding to the second cluster into a second recurring load use in the load usage dataset;
determining elasticity scores for the first recurring load use and the second recurring load use, wherein a higher elasticity score indicates a higher feasibility of reducing an extent of a load use;
comparing the requested load usage to the elasticity scores of the first recurring load use and the second recurring load use; and
based on the comparison, generating a recommendation to the user system for rebalancing load usage for a second period of time.

2. A method for recommending load rebalancing based on learned patterns of recurrence, the method comprising:
receiving a request from a user system to rebalance load usage, wherein the request comprises a requested load usage;
receiving a load usage dataset over a first period of time, wherein each entry in the load usage dataset corresponds to an instance of load use and specifies an amount and a category of the instance of load use;
determining similar instances based on a respective amount and respective category of each entry;
clustering the similar instances into a first cluster and a second cluster based on frequencies of the similar instances, wherein the first cluster corresponds to high-frequency similar instances, and wherein the second cluster corresponds to low-frequency similar instances;
combining one or more load uses corresponding to the first cluster into a first recurring load use in the load usage dataset;
combining one or more load uses corresponding to the second cluster into a second recurring load use in the load usage dataset;
comparing the requested load usage to the second recurring load use; and
generating a recommendation to the user system for rebalancing load usage for a second period of time based on comparing the requested load usage to the second recurring load use.

3. The method of claim 2, wherein determining similar instances comprises:
selecting a subset of parameters from a full set of parameters of the load usage dataset;
generating an embedding map that translates entries in the load usage dataset into a real-valued embedding space;
for each entry in the load usage dataset, using the embedding map to translate its values for the subset of parameters into the embedding space; and
calculating a distance matrix comprising distances between one or more entries.

4. The method of claim 3, further comprising:
selecting a distance threshold;
comparing each distance in the distance matrix against the distance threshold; and
detecting a group of instances, wherein for each pair of instances within the group of instances a distance in the distance matrix for the pair is shorter than the distance threshold.

5. The method of claim 4, wherein clustering the similar instances into the first cluster and the second cluster comprises:
retrieving a first set of frequency data for each instance in the group of instances;
selecting a threshold frequency based on the first set of frequency data and the distance matrix;
combining into the first cluster all instances in the group of instances that exceed the threshold frequency; and
combining into the second cluster all instances in the group of instances that do not exceed the threshold frequency.

6. The method of claim 2, wherein comparing the requested load usage to the second recurring load use further comprises:
determining a measure of discrepancy between the requested load usage and the load usage dataset;
determining that the second recurring load use is less than the measure of discrepancy; and
generating a recommendation to the user system that the requested load usage cannot be achieved.

7. The method of claim 3, wherein selecting the subset of parameters comprises:
generating a covariance matrix using the full set of parameters of the load usage dataset;
determining a set of eigenvectors for the covariance matrix;
selecting a measure of coverage;
selecting a subset of eigenvectors from the set of eigenvectors based on the measure of coverage; and
determining a subset of parameters corresponding to the subset of eigenvectors.

8. The method of claim 7, wherein selecting the subset of parameters comprises:
determining a set of eigenvectors for the covariance matrix;
determining a threshold value using a distribution of the set of eigenvectors; and
using a maximum-likelihood estimator model to select the subset of parameters from the covariance matrix, wherein the maximum-likelihood estimator model takes the threshold value as an input.

9. The method of claim 3, wherein using the embedding map to translate values for the subset of parameters into the embedding space comprises:
receiving as input a vector of parameter values representing an entry in the load usage dataset, wherein each parameter value corresponds to a parameter in the subset of parameters, and wherein the vector of parameter values comprises quantitative parameter values and categorical parameter values;
applying a preset vector of weights to the quantitative parameter values to generate new quantitative values for the quantitative parameter values;
using a set of deterministic rules to generate quantitative values for categorical parameter values; and
outputting the new quantitative values for the quantitative parameter values and quantitative values for categorical parameter values.

10. The method of claim 9, further comprising:
receiving a user request specifying that a parameter be removed from consideration or that impact of a parameter be reduced; and
applying a mathematical transformation to the vector of parameter values such that a parameter value corresponding to the parameter is adjusted.

11. The method of claim 3, wherein calculating a distance matrix comprises:
selecting a distance formula, wherein the distance formula is one of Euclidean distance, Cosine similarity, Jaccard Index, and Hamming distance;
using the distance formula, calculating a distance for each pair of entries in the load usage dataset;
calculating a frequency similarity score for each pair of entries in the load usage dataset, wherein the frequency similarity score represents a similarity between two entries in terms of frequency of occurrence; and
dividing the distance for each pair of entries in the load usage dataset by corresponding frequency similarity score.

12. The method of claim 4, wherein selecting a distance threshold comprises:
retrieving a preset maximum distance threshold;
determining a percentile rank for distances in the distance matrix;
determining a flexible distance threshold, wherein the flexible distance threshold is a distance at a particular percentile rank of distances in the distance matrix; and
setting the distance threshold to be the smaller of the flexible distance threshold and the preset maximum distance threshold.

13. A non-transitory computer-readable medium comprising instructions that, when executed by one or more processors, cause operations comprising:
receiving a requested load usage;
receiving a load usage dataset over a first period of time, wherein each entry in the load usage dataset corresponds to an instance of load use;
determining similar instances based on a respective amount and respective category of each entry;
clustering the similar instances into a first cluster and a second cluster based on frequencies of the similar instances;
combining one or more load uses corresponding to the first cluster into a first recurring load use in the load usage dataset;
combining one or more load uses corresponding to the second cluster into a second recurring load use in the load usage dataset;
comparing the requested load usage to the first and second recurring load uses; and
generating a recommendation for rebalancing load usage for a second period of time.

14. The non-transitory computer-readable medium of claim 13, wherein determining similar instances comprises:
selecting a subset of parameters from a full set of parameters of the load usage dataset;
generating an embedding map that translates entries in the load usage dataset into a real-valued embedding space;
for each entry in the load usage dataset, using the embedding map to translate its values for the subset of parameters into the embedding space; and
calculating a distance matrix comprising distances between one or more entries.

15. The non-transitory computer-readable medium of claim 14, further comprising:
selecting a distance threshold;
comparing each distance in the distance matrix against the distance threshold; and
detecting a group of instances, wherein for each pair of instances within the group of instances the distance in the distance matrix for the pair is shorter than the distance threshold.

16. The non-transitory computer-readable medium of claim 15, wherein clustering the similar instances into the first cluster and the second cluster comprises:
retrieving a first set of frequency data for each instance in the group of instances;
selecting a threshold frequency based on the first set of frequency data and the distance matrix;
combining into the first cluster all instances in the group of instances that exceed the threshold frequency; and
combining into the second cluster all instances in the group of instances that do not exceed the threshold frequency.

17. The non-transitory computer-readable medium of claim 14, wherein selecting the subset of parameters comprises:
generating a covariance matrix using the full set of parameters of the load usage dataset;
determining a set of eigenvectors for the covariance matrix;
selecting a measure of coverage;
selecting a subset of eigenvectors from the set of eigenvectors based on the measure of coverage; and
determining a subset of parameters corresponding to the subset of eigenvectors.

18. The non-transitory computer-readable medium of claim 14, wherein using the embedding map to translate values for the subset of parameters into the embedding space comprises:
receiving as input a vector of parameter values representing an entry in the load usage dataset, wherein each parameter value corresponds to a parameter in the subset of parameters, and wherein the vector of parameter values comprises quantitative parameter values and categorical parameter values;
applying a preset vector of weights to the quantitative parameter values to generate new quantitative values for the quantitative parameter values;
using a set of deterministic rules to generate quantitative values for categorical parameter values; and
outputting the new quantitative values for the quantitative parameter values and quantitative values for categorical parameter values.

19. The non-transitory computer-readable medium of claim 18, further comprising:
receiving a user request specifying that a parameter be removed from consideration or that impact of a parameter be reduced; and
applying a mathematical transformation to the vector of parameter values such that a parameter value corresponding to the parameter is adjusted.

20. The non-transitory computer-readable medium of claim 14, wherein calculating a distance matrix comprises:
selecting a distance formula, wherein the distance formula is one of Euclidean distance, Cosine similarity, Jaccard Index, and Hamming distance;
using the distance formula, calculating a distance for each pair of entries in the load usage dataset;
calculating a frequency similarity score for each pair of entries in the load usage dataset, wherein the frequency similarity score represents a similarity between two entries in terms of frequency of occurrence; and
dividing the distance for each pair of entries in the load usage dataset by corresponding frequency similarity score.
